(19) United States
(12) Patent Application Publication
(10) Pub. No.: US 2017/0201819 A1
(43) Pub. Date: Jul. 13, 2017

(54) WEARABLE ELECTRONIC DEVICE

(71) Applicant: ALTEK CORPORATION, Hsinchu City (TW)

(72) Inventors: Wei-Che Chang, New Taipei City (TW); Chao-Chang Mai, Taipei City (TW)

(21) Appl. No.: 15/146,883

(22) Filed: May 4, 2016

(30) Foreign Application Priority Data
Jan. 13, 2016 (TW) 105200430

(51) Int. Cl. H04R 1/10; H04R 3/00

(52) U.S. Cl. CPC H04R 1/1033; H04R 1/1016; H04R 3/00

(57) ABSTRACT

A wearable electronic device including a first main body, a second main body, a wire, a first magnetic component and a second magnetic component is provided. The two ends of the wire are respectively connected to the first main body and the second main body. The first magnetic component is disposed on the first main body, and the second magnetic component is disposed on the second main body. The first magnetic component and the second magnetic component are attracted to each other along a direction parallel to an axis, so as to form a receiving structure. The first main body and the second main body rotate in relative to each other along the axis, so as to furl the wire into the receiving structure, and at least one of the first main body and the second main body includes an electronic component.

### CROSS-REFERENCE TO RELATED APPLICATION

This application claims the priority benefit of Taiwan application serial no. 105200430, filed on Jan. 13, 2016. The entirety of the above-mentioned patent application is hereby incorporated by reference herein and made a part of this specification.

### BACKGROUND OF THE INVENTION

1. Field of the Invention

The invention generally relates to a wearable electronic device, and more particularly to, a wearable electronic device having a wire receiving structure.

2. Description of Related Art

As technology industry continue to advances, forms, functionalities and usages of electronic devices become more and more diverse. At the same time, as the electronic devices continue to develop towards a trend of thin and light, the electronic devices become much easier to carry, thereby also accelerating the popularity of the electronic devices. In recent year, in order to further increase the convenience of portable electronic devices, many wearable electronic devices capable of being directly worn on a user body have correspondingly been developed. Functions of the conventional wearable electronic devices typically includes a display function, an image capturing function, a touch function, a physiological monitoring function or wireless earphone function, etc.

The wearable electronic devices generally have various connecting wires, and when the wearable electronic devices are to be stored, the connecting wires are often tended to be entangled with each other. Therefore, the wearable electronic device is usually required to be additionally disposed with and relied on a wire receiving structure, such as a reel or an independently designed receiving groove, to receive or store the wire.

However, by additionally disposing a wire receiving device or structure on the wearable electronic device, the overall volume of the wearable electronic device is increased, thereby lowering a wearability and portability of the wearable electronic device while also increasing a storage space required by the wearable electronic device. As a result, the overall production cost of the wearable electronic device is also increased.

### SUMMARY OF THE INVENTION

The invention provides a wearable electronic device having a receiving structure formed by attaching magnet components with each other so as to be used for receiving a wire connecting main bodies of the wearable electronic device.

The invention provides a wearable electronic device including a first main body, a second main body, a wire, a first magnetic component and a second magnetic component. Two ends of the wire are respectively connected to the first main body and the second main body. The first magnetic component is disposed on the first main body, and the second magnetic component is disposed on the second main body. The first magnetic component and the second magnetic component are attracted to each other along a direction parallel to an axis so as to form a receiving structure between the first main body and the second main body. The first main body and the second main body rotate in relative to each other along the axis so as to furl the wire into the receiving structure, and at least one of the first main body and the second main body includes an electronic component.

In one embodiment of the invention, the first magnetic component and the second magnetic component are strong magnets.

In one embodiment of the invention, the first main body includes an electronic component, and the second main body includes a power supply unit.

In one embodiment of the invention, the power supply unit is electrically connected to the electronic component through the wire so as to supply power to the electronic component.

In one embodiment of the invention, the electronic component includes an image capturing element, a display element or a physiological signal sensing element.

In one embodiment of the invention, the wearable electronic device further includes a wireless transmission unit disposed in the first main body or the second main body.

In one embodiment of the invention, the wearable electronic device is a wireless earphone device.

In one embodiment of the invention, the first main body and the second main body are respectively earphone bodies of the wireless earphone device.

In one embodiment of the invention, the wearable electronic device further includes a cladding material, and the cladding material is coated on a surface of the wire.

In view of the above, in the embodiments of the invention, the wearable electronic device has the first main body and the second main body which are connected with each other through the wire. In addition, the first magnetic component and the second magnetic component may be respectively disposed on the first main body and the second main body. The first magnetic component and the second magnetic component are attracted to each other to form the receiving structure between the first main body and the second main body. A user may furl the wire into the receiving structure through rotating the first main body and the second main body in relative to each other. As a result, the wearable electronic device as described in the embodiments of the invention is not required to be additionally disposed with an independent wire receiving device or structure, and thus can further reduce an overall volume and a production cost of the wearable electronic device, thereby enabling the wearable electronic device to become more convenient in carrying and storage.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram illustrating a wearable electronic device according to an embodiment of the invention.

FIG. 2 is a schematic diagram illustrating an implementation of the wearable electronic device of FIG. 1.

FIG. 3 is a schematic diagram illustrating a wearable electronic device according to another embodiment of the invention.

FIG. 4 is a schematic diagram illustrating a wearable electronic device according to yet another embodiment of the invention.

### DESCRIPTION OF THE EMBODIMENTS

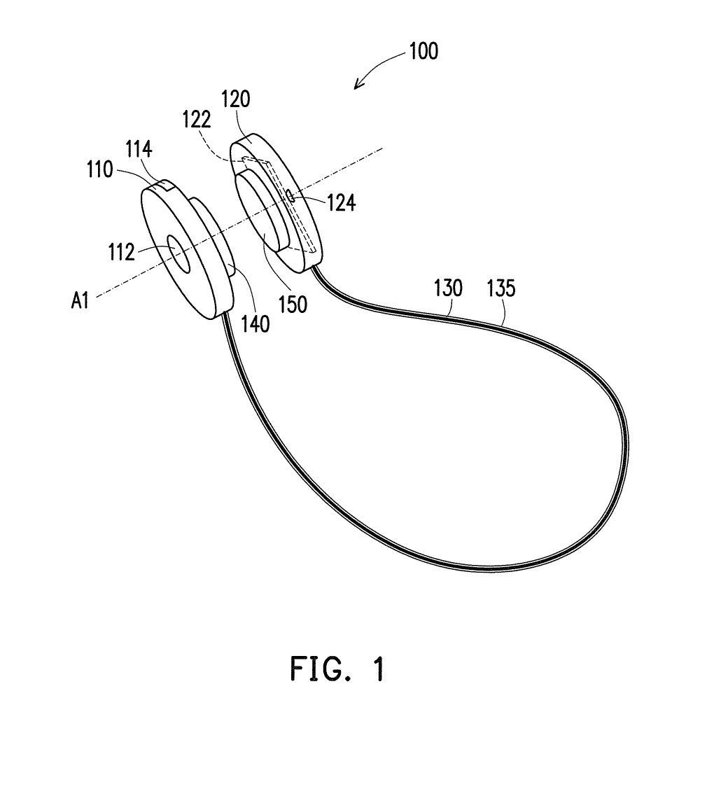

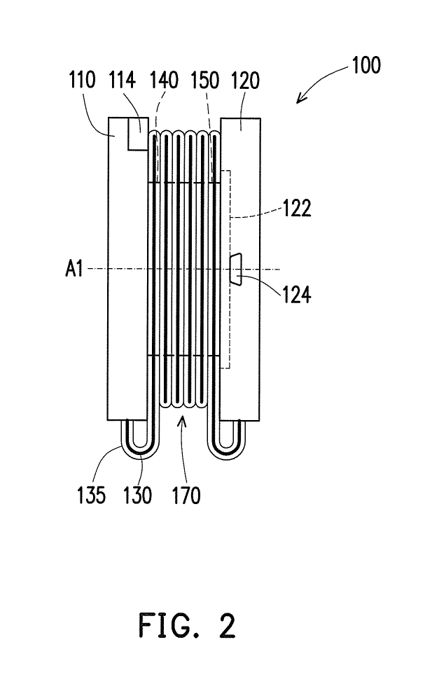

FIG. 1 is a schematic diagram illustrating a wearable electronic device 100 according to an embodiment of the invention. FIG. 2 is a schematic diagram illustrating an implementation of the wearable electronic device 100 of FIG. 1. Referring to FIG. 1 and FIG. 2, in the present embodiment, the wearable electronic device 100 has a first main body 110, a second main body 120, a wire 130, a first magnetic component 140 and a second magnetic component 150. Two ends of the wire 130 are respectively connected to the first main body 110 and the second main body 120. The first magnetic component 140 is disposed on the first main body 110, and the second magnetic component 150 is disposed on the second main body 120. As shown in FIG. 2, the first magnetic component 140 and the second magnetic component 150 may be magnetically attracted to each other along a direction parallel to an axis A1 so as to form a receiving structure 170 between the first main body 110 and the second main body 120. With the characteristic in which the first magnetic component 140 and the second magnetic component 150 can still rotate in relative to each other after attracting to each other, a user of the wearable electronic device 100 can rotate the first magnetic component 140 and the second magnetic component 150 in relative to each other along the axis A1 to furl the wire 130 into the receiving structure 170 between the first main body 110 and the second main body 120.

In the present embodiment, the wearable electronic device 100 can form the receiving structure 170 between the first and second main bodies 110, 120 by enabling the first magnetic component 140 and the second magnetic component 150 thereof to be attracted to each other, and the wire 130 can be furled into the receiving structure 170 through rotating the first main body 110 and the second main body 120 in relative to each other along the axis A1. Therefore, the wearable electronic device 100 of the present embodiment does not required to be additionally and independently disposed with other wire receiving device or structure for receiving the wire 130. Accordingly, the wearable electronic device 100 of the present embodiment does not additionally increase the volume or the production cost of the wearable electronic device 100 while using the receiving structure 170 to receive the wire 130.

The first magnetic component 140 and the second magnetic component 150 of the present embodiment are, for example, strong magnets, which can increase an ability for the first magnetic component 140 and the second magnetic component 150 to attract to each other. Moreover, in addition to forming the receiving structure 170 for receiving the wire 130 by means of attaching the first magnetic component 140 and the second magnetic component 150 with each other, the user of the wearable electronic device 100 may also clip the wearable electronic device 100 onto a clothing or a variety of portable accessories by means of attaching the first and second magnetic components 140, 150 with each other. Furthermore, the first magnetic component 140 and the second magnetic component 150 with the magnetism thereof can respectively be directly attached onto a magnetic wall or a variety of home appliances (e.g., a refrigerator) which has a magnetic surface.

A shape of the first magnetic component 140 and the second magnetic component 150 of the present embodiment is configured corresponding to a shape of the first main body 110 and the second main body 120 (such as a circle shown in FIG. 1). In other embodiments which are not shown, the shape of the first and second main bodies 110, 120 and the corresponding shape of the first and second magnetic components 140, 150 may also be rectangular, polygonal or other irregular shapes, etc. The shapes of the first and second main bodies 110, 120 and the first and second magnetic components 140, 150 may undergo different design adjustments or changes according to the needs of the user of the wearable electronic device 100.

In the present embodiment, the wearable electronic device 100 is, for example, a wearable image capturing device, and the first main body 110 includes, for example, an electronic component, such as an image capturing element 112, and the image capturing element 112 and the first magnetic component 140 are respectively disposed on two opposite surfaces of the first main body 110. In addition, the second main body 120 includes a power supply unit 122 which is, for example, a battery module. The power supply unit 122 can be electrically connected to the image capturing element 112 through the wire 130 so as to supply power to the image capturing element 112. Otherwise, the power supply unit 122 may also directly charge the image capturing element 112 by means of wireless charging. Furthermore, the second main body 120 has a connector slot 124, so the wearable electronic device 100 may be connected to an external power source or an external data access device (not shown) through a connector such as a micro USB. In another embodiment which is not shown, the connector slot 124 may also be disposed on the first main body 110. The type and the configuration location of the connector slot 124 of the invention may be appropriately modified according to requirements of practical application.

In the present embodiment, the wearable electronic device 100 can further has a cladding material 135 coated on a surface of the wire 130, so as to increase the aesthetics, the comfort and the safety of the wearable electronic device 100 when it is being worn by the user. For instance, the surface of the wire 130 can be wrapped by a cladding material 135 constituted by a soft plastic material such as rubber. Thus, the user may wear the wearable electronic device 100 on the wrist, the neck or the forehead via the wire 130. Particularly, when the wire 130 serves as a conductive wire electrically connected to the image capturing element 112 and the power supply unit 122, the cladding material 135 coated on the surface of the wire 130 may increase the insulation and the safety of the wire 130 when it contacts the human body.

The first main body 110 of the wearable electronic device 100 of the present embodiment may be disposed with a wireless transmission unit 114 thereon. For instance, the first main body 110 of the present embodiment has the wireless transmission unit 114, and the wireless transmission unit 114 is electrically connected to the image capturing element 112. Thus, the image capturing element 112 may transmit an image being captured to a mobile computing device (not shown), such as a mobile phone or a Tablet PC, through the wireless transmission unit 114 by means of wireless transmission, such as Bluetooth or WiFi, so as to display the image captured by the image capturing element 112 in the mobile computing device. In another embodiment which is not shown, the wireless transmission unit 114 may also be disposed on the second main body 120, and be electrically connected to the image capturing element 112 through the wire 130. The invention does not intend to limit the configuration location of the wireless transmission unit 114.

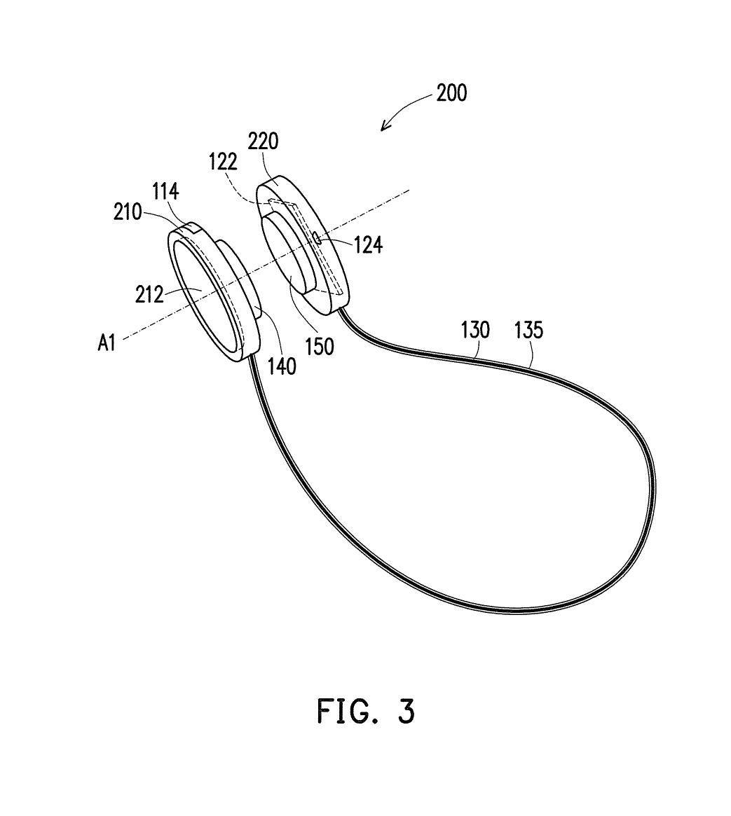

FIG. 3 is a schematic diagram illustrating a wearable electronic device 200 according to another embodiment of the invention. In the present embodiment, a structure of the wearable electronic device 200 is similar to that of the wearable electronic device 100 of FIG. 1. Thus, identical or similar components are represented by the same or similar notations, and descriptions thereof are omitted. In the present embodiment, the wearable electronic device 200 is, for example, a wearable display device. In addition, the wearable electronic device 200 includes a first main body 210 and a second main body 220. The first main body 210 has a display element 212, and the display element 212 and the first magnetic component 140 are respectively disposed on two opposite surfaces of the first main body 210. The display element 212 of the present embodiment is, for example, a touch display element capable of displaying information such as time, date, map, weather and so forth. Moreover, the display element 212 can be electrically to the mobile computing device, such as the mobile phone or the Tablet

PC, through the wireless transmission unit 114. Thus, an incoming call or an instant message from the mobile phone or the Tablet PC can be displayed on the display element 212, and the user can directly answer the incoming call or reply the instant message from the mobile phone via the display element 212.

In addition, the wearable electronic device 200 may also be disposed with a physiological signal sensing element (not shown) thereon. The user can wear the wearable electronic device 200 on the wrist or other parts of the human body so as to timely measure and monitor physiological signals (e.g., heartbeat, body temperature and respiration rate) of the user and to display the physiological signals on the display element 212. In addition, the physiological signal sensing element may be electrically connected to the wireless transmission unit 114 to transmit the physiological signal of the user wearing the wearable electronic device 200 to the mobile computing device, such as the mobile phone or the Tablet PC, or a remote server, so as to perform real-time observation and monitoring.

In the present embodiment, since the wearable electronic device 200 has the first magnetic component 140 and the second magnetic component 150, the user can also use the magnet components to directly attach the wearable electronic device 200 onto, for example, an office clapboard, a classroom whiteboard or blackboard, or a refrigerator door at home so as to serve as a status display or timekeeping tool. Moreover, since the wire 130 of the wearable electronic device 200 of the present embodiment can directly be stored into the receiving structure 170 formed by the first magnetic component 140 and the second magnetic component 150 that are attracted to each other, the wearable electronic device 200 becomes even more convenient to carry and use, and thus it is much easier for the user to use various functions of the wearable electronic device 200 at anywhere.

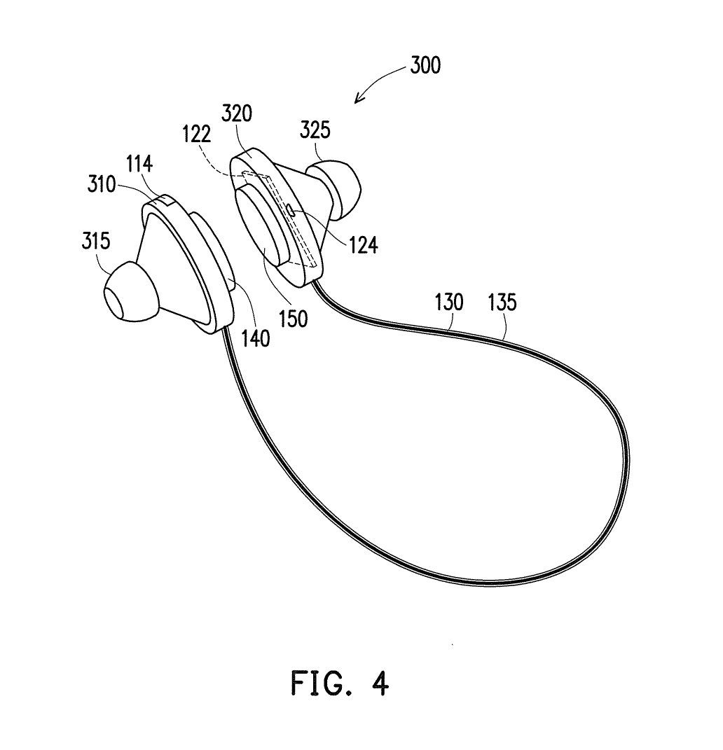

FIG. 4 is a schematic diagram illustrating a wearable electronic device 300 according to yet another embodiment of the invention. In the present embodiment, a structure of the wearable electronic device 300 is similar to that of the wearable electronic device 100 of FIG. 1. Thus, identical or similar components are represented by the same or similar notations, and descriptions thereof are omitted. In the present embodiment, the wearable electronic device 300 is, for example, a wireless earphone device, and the wire 130 can server as an earphone cable. The user can hang the wearable electronic device 300 on the neck with the wire 130. The wearable electronic device 300 has a first earphone body 310 and a second earphone body 320, which are respectively disposed on opposite sides of the first magnetic component 140 and the second magnetic component 150. Moreover, the first earphone body 310 and the second earphone body 320 may be respectively disposed with a first fixing portion 315 and a second fixing portion 325 thereon, so that the user can respectively fix the first earphone body 310 and the second earphone body 320 on the right ear and the left ear when wearing the wearable electronic device 300.

As shown in FIG. 4, the first fixing portion 315 and the second fixing portion 325 of the present embodiment are, for example, earbud style fixing structures. In other embodiments which are not shown, the first fixing portion 315 and the second fixing portion 325 may also be fixing structures of other style. The invention does not intend to limit the forms of the first fixing portion 315 and the second fixing portion 325, such that the forms of the first fixing portion 315 and the second fixing portion 325 can be appropriately modified and changed according to a usage scenario and state of the wearable electronic device 300.

In the present embodiment, after the user finishes using the wearable electronic device 300, the user can attach the first magnetic component 140 and the second magnetic component 150, which are respectively disposed on the first earphone body 310 and the second earphone body 320, with each other so as to form the receiving structure 170. Next, the user can rotate the first earphone body 310 and the second earphone body 320 in relative to each other so as to furl the wire 130 of the wearable electronic device 300 into the receiving structure 170, and thus the wearable electronic device 300 can be easy to store and carry. In addition, since the receiving structure 170 of the present embodiment is formed between the first earphone body 310 and the second earphone body 320 by magnetically attaching the first magnetic component 140 and the second magnetic component 150 of the wearable electronic device 300 with each other, the wearable electronic device 300 is not required to additionally be disposed with other independent receiving device or structure. Therefore, as compared to a typical wireless earphone device, the volume and the production cost of the wearable electronic device 300 can be effectively reduced.

In summary, the wearable electronic device in the embodiments of the invention has the first main body and the second main body that are connected to each other through the wire. The wearable electronic device is, for example, a wearable image capturing device, a display device or a wireless earphone device. The first main body and the second main body respectively have the first magnetic component and the second magnetic component thereon. The first magnetic component and the second magnetic component may be attracted to each other to form the receiving structure between the first main body and the second main body. The user rotates the first main body and the second main body that are attracted to each other in relative to each other, so as to furl the wire into the receiving structure formed between the first main body and the second main body. Since the receiving structure in the embodiments of the invention is directly form between the first main body and the second main body of the wearable electronic device, the receiving structure does not additionally increase the overall volume of the wearable electronic device while providing a simple and convenient storage means to the wire, thereby enabling the wearable electronic device to become much easier to store and carry. In addition, since the wearable electronic device in the embodiments of the invention is not required to be additionally disposed with other wire receiving device or structure, material and production cost of the wearable electronic device can also be effectively lowered.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A wearable electronic device, comprising:
a first main body;
a second main body;
a wire, wherein two ends of the wire are respectively connected to the first main body and the second main body;
a first magnetic component, disposed on the first main body; and
a second magnetic component, disposed on the second main body, wherein the first magnetic component and the second magnetic component are attracted to each other along a direction parallel to an axis so as to form a receiving structure between the first main body and the second main body, the first main body and the second main body rotate in relative to each other along the axis so as to furl the wire into the receiving structure, and at least one of the first main body and the second main body includes an electronic component.

2. The wearable electronic device as recited in claim 1, wherein the first magnetic component and the second magnetic component are strong magnets.

3. The wearable electronic device as recited in claim 1, wherein the first main body comprises an electronic component, and the second main body comprises a power supply unit.

4. The wearable electronic device as recited in claim 3, wherein the power supply unit is electrically connected to the electronic component through the wire so as to supply power to the electronic component.

5. The wearable electronic device as recited in claim 3, wherein the electronic component comprises an image capturing element, a display element or a physiological signal sensing element.

6. The wearable electronic device as recited in claim 1, further comprising a wireless transmission unit disposed in the first main body or in the second main body.

7. The wearable electronic device as recited in claim 1, wherein the wearable electronic device is a wireless earphone device.

8. The wearable electronic device as recited in claim 7, wherein the first main body and the second main body are respectively earphone bodies of the wireless earphone device.

9. The wearable electronic device as recited in claim 1, further comprising a cladding material, wherein the cladding material is coated on a surface of the wire.
